(19) United States
(12) Patent Application Publication
(10) Pub. No.: US 2015/0290676 A1
(43) Pub. Date: Oct. 15, 2015

(54) BONDING METHOD

(71) Applicant: ADVANCED INSULATION PLC, GLOUCESTER, GLOUCESTERSHIRE (GB)

(72) Inventor: Simon Shepherd, Gloucestershire (GB)

(73) Assignee: ADVANCED INSULATION PLC, GLOUCESTER, GLOUCESTERSHIRE (GB)

(21) Appl. No.: 14/403,068

(22) PCT Filed: May 21, 2013
(86) PCT No.: PCT/GB2013/051323

§ 371 Date: Nov. 21, 2014

(30) Foreign Application Priority Data
Jun. 1, 2012 (GB) 1209879.4

(51) Int. Cl. B05D 3/06; C09D 157/00; B05D 1/38; C09D 187/00; B05D 1/28; B05D 1/02

(52) U.S. Cl. CPC B05D 3/068; B05D 1/28; B05D 1/02; B05D 1/38; C09D 187/00; C09D 157/00

(57) ABSTRACT

A silicone based insulation layer for subsea use is applied onto subsea structures such as pipeline components by plasma treating the subsea structure, applying a siloxane primer thereto, allowing the primer to cure, and applying the insulation layer uncured onto the primer so that as the insulation material cures it also bonds onto the treated subsea structure.

This invention concerns a method of bonding together two materials.

A number of low energy dissimilar materials are difficult to bond together, and particularly to securely bond together. It may though be desired to bond such materials together to obtain the characteristics of each material. One such situation is to provide joints or insulation for subsea equipment as may be used in hydrocarbon facilities. In such instances it is required to provide a bond which will be strong and long lasting in the harsh operating conditions experienced subsea. One such material is platinum cured silicone which when cured, generally only bonds well to other platinum cured silicones.

According to the present invention there is provided a method of bonding together two materials, the method comprising plasma treating an external surface of a first material, applying a primer to said external surface of the first material, and applying a second material in an uncured condition onto said external surface such that as the second material cures it bonds onto said external surface.

The primer may be silane based, may be a solution or mixture of polyorganosiloxanes, and may be a solution of siloxanes and silicone resins in a mixture of isoalkanes.

A dwell time may be provided after application of the primer and prior to application of the second material, and the dwell time may be between one and five hours.

The primer may be applied by brushing, wiping or blowing. In one embodiment the primer may be applied using a nozzle attached to a plasma gun so that primer is only applied where plasma treating has taken place.

The second material may be in two part form, and the two parts may be mixed immediately prior to application onto said external surface.

The plasma treating may be carried out using an air plasma generator. The plasma generator may be spaced at a distance of between 4 and 25 mm from the first material during treatment, particularly at a distance of 6 to 16 mm, and more particularly at a distance of 8 to 12 mm.

The second material may be applied as a coating, or may be applied in a mould to provide a profiled outer layer to a component made of the first material.

The first material may be any of: polypropylene, polyether ether ketone (PEEK), solid polyurethane, polyether, modified polyether, glass syntactic polyurethane, thermotite deep foam, phenolic based syntactic insulation, or phenolic based GRP.

The second material may comprise any of: silicone based subsea insulation materials such as solid silicone, platinum cured silicone solid polyurethane or glass syntactic polyurethane.

The invention also provides a method for bonding together two materials for use in subsea conditions, the method being according to any of the preceding eight paragraphs.

An embodiment of the present invention will now be described by way of example only.

A silicone based insulation layer for subsea use is applied onto subsea structures such as pipeline components for transporting hydrocarbon fluids subsea. The components may be coated in polypropylene.

Firstly the exterior of the components is cleaned with an appropriate solvent such as acetone or IMS (industrial methylated spirit). An air plasma gun is set up above a belt conveyor and the components are placed on the conveyor such that the distance between the gun and the conveyor is at a required, distance which in this instance may be around 10 mm. The speed of the belt conveyor is set to provide required plasma treatment, in this instance a speed of around 10 m per minute is set.

The components are passed beneath the plasma gun and treated. A static or rotating plasma jet nozzle can be used to achieve the required treatment width. For instance a treatment width of 25 mm may be applied, and subsequent treatment following movement of the components may be necessary to treat the whole external surface thereof.

Once the plasma treatment has been completed a siloxane primer is applied on the treated surface by wiping with a lint free cloth to provide a thin layer. The usual coverage may be between 40 and 60 mg/m2. In this instance the primer is a solution of siloxanes and silicone resins in a mixture of isoalkanes. This primer is a moisture cured material and needs to be left for at least an hour, and generally for less than 5 hours.

Once the primer has cured, platinum cured silicone based insulation material is applied uncured onto the components. The components may be located in a mould and the silicone insulation material is poured into the mould prior to curing. As the silicone insulation material cures it also bonds onto the treated components, by virtue of the primer layer on the plasma treated surface.

Using this method it has been found that the bonding strength between the silicone insulation material and the component is actually greater than the strength of the silicone material itself.

There is thus provided a method of bonding together low surface energy substances, to provide a very strong bond which is suitable for use in subsea conditions. The method can readily be carried out, with conditions being varied as required for particular situations and materials.

It is to be realised that a wide range of different conditions and components may be used in the method. For instance the plasma treated material can comprise any of a wide range of different materials including PEEK, solid pure polyurethane, polyether, modified polyether, glass syntactic polyurethane, thermotite deep foam, phenolic based syntactic insulation or phenolic based GRP.

The material applied onto the cured material can also be drawn from a range of materials, including a range of silicone based subsea insulation materials such as solid silicone or Novolastic, solid polyurethane or glass syntactic polyurethane.

Different conditions may be applied during the method. The plasma treatment may be carried out at a different distance and/or by a different way as required dependent on the material of the component.

The primer can be applied by a different method such as brushing or blowing. The blowing could be from a nozzle attached to the plasma generator to ensure that the primer is only applied where plasma treatment has taken place. Different siloxane primers can be used.

Rather than being applied in a mould, the uncured material could be provided just as a coating around a component.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method of bonding together two materials, the method comprising plasma treating an external surface of a first material, applying a primer to said external surface of the first material, and applying a second material in an uncured condition onto said external surface such that as the second material cures it bonds onto said external surface.

2. A method according to claim 1, in which the primer is silane based.

3. A method according to claim 2, in which the primer is a solution or mixture of polyorganosiloxanes.

4. A method according to claim 3, in which the primer is a solution of siloxanes and silicone resins in a mixture of isoalkanes.

5. A method according to claim 1, in which a dwell time is provided after application of the primer and prior to application of the second material.

6. A method according to claim 5, in which the dwell time is between one and five hours.

7. A method according to claim 1, in which the primer is applied by brushing, wiping or blowing.

8. A method according to claim 1, in which the primer is applied using a nozzle attached to a plasma gun so that primer is only applied where plasma treating has taken place.

9. A method according to claim 1, in which the second material is in two part form.

10. A method according to claim 9, in which the two parts are mixed immediately prior to application onto said external surface.

11. A method according to claim 1, in which the plasma treating is carried out using an air plasma generator.

12. A method according to claim 11, in which the plasma generator is spaced at a distance of between 4 and 25 mm from the first material during treatment.

13. A method according to claim 12, in which the plasma generator is spaced at a distance of 6 and 16 mm from the first material during treatment.

14. A method according to claim 13, in which the plasma generator is spaced at a distance of 8 and 12 mm from the first material during treatment.

15. A method according to claim 1, in which the second material is applied as a coating.

16. A method according to claim 1, in which the second material is applied in a mould to provide a profiled outer layer to a component made of the first material.

17. A method according to claim 1, in which the first material is any of: polypropylene, polyether ether ketone (PEEK), solid polyurethane, polyether, modified polyether, glass syntactic polyurethane, thermotite deep foam, phenolic based syntactic insulation, or phenolic based GRP.

18. A method according to claim 1, in which the second material comprises any of: silicone based subsea insulation materials such as solid silicone, platinum cured silicone solid polyurethane or glass syntactic polyurethane.

19. (canceled)
